(19) United States
(12) Patent Application Publication
(10) Pub. No.: US 2026/0052345 A1
(43) Pub. Date: Feb. 19, 2026

(54) ELECTROACOUSTIC TRANSDUCER

(71) Applicant: ARYA AUDIO LABS LTD, London (GB)

(72) Inventors: Arthur Marker, London (GB); William Andres Cardenas Patiño, London (GB); Dominika Behounek, London (GB)

(21) Appl. No.: 19/102,310

(22) PCT Filed: Aug. 8, 2023
(86) PCT No.: PCT/GB2023/052097

§ 371 Date: Feb. 7, 2025

Related U.S. Application Data
(60) Provisional application No. 63/370,719, filed on Aug. 8, 2022.

(51) Int. Cl. H04R 9/02; H04R 7/14; H04R 9/06

(52) U.S. Cl. CPC H04R 9/025; H04R 7/14; H04R 9/06

(57) ABSTRACT

There is provided a magnetic structure for an air motion transformer (AMT) electroacoustic transducer comprising a diaphragm assembly (7), wherein the magnetic structure comprises at least one magnet (6) positioned at least partially within the diaphragm assembly (7).

### TECHNICAL FIELD

The present invention relates to electroacoustic transducers and systems, such as loudspeakers and loudspeaker systems, specifically of the air motion transformer (AMT) type, and their magnetic motor structure. In particular, the present invention relates to a distributed magnet array for multilayer thin-film electroacoustic transducers.

### BACKGROUND

The field of loudspeaker transducers is dominated by the dynamic driver which can be easily identified by their typically cone-or dome-shaped diaphragms. Despite variations in the design specifics, they all operate on the same principle where a voice coil connected to the diaphragm is moving inside the magnetic gap of a magnet structure by means of the electromagnetic force thus producing sound. In this type of transducer, the effective area capable of moving the air is equivalent to the visible surface area of the diaphragm.

However, there exists a whole group of electroacoustic transducers with a ‘meander-shaped’ (or ‘pleated’) diaphragm made out of insulating thin-foil or thin-film, or another type of thin flexible or semi-rigid substrate that carries the electrically conductive traces on its surface, thereby eliminating the need for a separate voice coil. Due to their inherently greater effective area and low moving mass, the so-called “air motion transformer” provides excellent air coupling resulting in superb transient response and very low distortion.

A number of embodiments of the air motion transformer, also referred to by those skilled in the art as ‘AMT’, are described in U.S. Pat. No. 3,636,278 by its inventor Oskar Heil. The quintessential working principle of the AMT describes a plurality of substantially parallel vibratory diaphragm layers, alternately closed in the front or at the back (in a ‘meander’ or ‘pleated’ structure), with semi-confined air pockets in between the layers, creating an acoustic dipole. The electrical conductors bonded onto the membrane substrate are arranged such that the path of charged particles moving through the conductive traces is substantially perpendicular to the magnetic field created by the motor structure, all the while the current in adjacent layers is flowing in opposite directions. The resulting Lorentz force causes the adjacent diaphragm layers to either move toward or away from each other, depending on the direction of the current, producing an acoustic output substantially parallel to the diaphragm layers.

Modified embodiments of the original AMT designs were described in numerous other patents including, for example, a ‘reinforced’ version of the AMT detailed in U.S. Pat. No. 8,208,678 B2, where each crest of a pleated section of the diaphragm is reinforced with a stiffness-providing element controlling the parasitic oscillations.

Another instance of an AMT variation is described in U.S. Pat. No. 9,124,964 B2, where the parallel diaphragm layers are curved in an effort to control the directivity of the acoustic output. Nevertheless, the main operating principle remains the same with the active element consisting of a multilayer film diaphragm submerged in a strong magnetic field.

The aforementioned air motion transformer devices and their magnetic motor structures all share a variety of limitations. Since permanent magnets are dipoles, their magnetic field rapidly decays with distance in accordance with the inverse cube law. For that reason, one of the main challenges in thin-film multilayer transducers is to create a magnetic field strong enough to drive the diaphragm layers, which is difficult due to the large magnetic gap dictated by the width of the diaphragm structure. The prior-art motors usually consist of a combination of permanent magnets as well as pole pieces made out of soft magnetic materials placed directly in front of and behind the diaphragm. The purpose of using pole piece elements is to direct as much of the magnetic flux across the diaphragm as possible, thus limiting stray fields and enhancing the transducer's efficiency. However, this placement of the pole pieces obstructs the outlets of the vibratable diaphragm, diminishing acoustic transparency and introducing cavity effects that negatively influence the high-frequency response of the transducer. Alternatively, omitting the pole piece elements would bring about problems with the increased amount of stray fields and reduced efficiency of the transducer, limiting the acoustic output it is capable of producing.

Therefore, an undeniable need exists to optimize the construction of AMT transducers and their magnetic motor structures to fully make use of the advantages the air motion transformer can offer in the field of sound reproduction.

### SUMMARY OF THE INVENTION

Aspects and embodiments of the present invention are set out in the appended claims. These and other aspects and embodiments of the invention are also described herein.

It is an object of the present invention to provide a novel motor configuration for AMT transducers wherein multiple magnets are distributed within the bounds of the diaphragm assembly (for example, a stack) in between the individual diaphragm layers, bringing the magnets closer to the conductive traces. This novel configuration facilitates an ironless motor design for air motion transformers, eliminating the need to use additional pole pieces (for example made of soft magnetic materials). Additionally, the disclosure provides a solution for removing obstructions from the acoustic output path of AMT transducers.

According to a first aspect of the invention, there is provided a magnetic structure for an air motion transformer (AMT) electroacoustic transducer comprising a diaphragm assembly, wherein the magnetic structure comprises at least one magnet positioned at least partially within the diaphragm assembly.

This provides the advantage that the magnetic flux is locally directed (more efficiently directed) to the layers of the diaphragm. As used herein, being positioned ‘within’ preferably connotes being positioned within the geometrical structure of the diaphragm assembly; this may alternatively be described as being within the same volume (i.e. volume of space) occupied by the diaphragm assembly. This applies to any shape the diaphragm assembly may take. The entire magnet may or may not be positioned within the diaphragm assembly, hence one or more magnets may be provided at least partially within the diaphragm assembly. For example, only a part of one or more magnets may be within the structure. The relevant portion of diaphragm assembly may be referred to as the (vibratable) layers of the diaphragm assembly, for example the structure formed by the (vibratable) layers of the diaphragm assembly. The (vibratable) layers of the diaphragm assembly may form a geometrical structure of a variety of shapes, for example a ‘straight’ configuration having a generally cuboidal shape, or a more complex shape, such as ‘curved structure’. The ‘magnetic structure’ may alternatively be described in relation to the ‘magnet structure’.

The at least one magnet may be positioned at least partially within the bounds of the diaphragm assembly, preferably within the geometrical bounds of the diaphragm assembly. As used herein, being positioned ‘within the bounds’ preferably connotes being positioned within the boundary or perimeter of the geometrical structure of the diaphragm assembly.

The at least one magnet may be positioned at least partially within the footprint of the diaphragm assembly. As used herein, the term “at least partially within the footprint” preferably connotes being at least partially within the geometrical area projection of the diaphragm assembly in all directions (orientations).

In preferable implementations, the at least one magnet is provided between adjacent vibratable layers of the diaphragm assembly. This can facilitate the magnetic flux being provided directly and efficiently across the vibratable layers. This preferably refers to the magnet being positioned within the volume defined between adjacent vibratable layers, for example within the volume defined between the planes of two adjacent vibratable layers. The vibratable layers of the diaphragm assembly may comprise at least one electric conductor. The vibratable layers of the diaphragm assembly may be vibratable in order to propagate sound. At least a part of the magnet may be provided between two adjacent layers (the magnet may be provided at least partially between the layers).

In some implementations, the magnetic structure may further comprise at least one further magnet outside the diaphragm assembly. This can further enhance the magnetic flux across the diaphragm assembly. The at least one further magnet may be provided adjacent to at least one side of the diaphragm assembly. As used herein, the term ‘side’ preferably connotes all sides of the diaphragm assembly, encompassing ‘top’, ‘bottom’, ‘end’, and so on. This may preferably encompass all sides of a complex shape. The term ‘side’ may encompass all positions or locations adjacent to any face of the shape. Different portions, sections or parts of the magnetic structure may utilize different arrangements of magnets within and outside the diaphragm stack. This may be, for example, to configure different portions, sections or parts for different frequency ranges.

In some implementations, the magnetic structure may further comprise at least one pole piece component. This can assist in directing and enhancing magnetic flux. The at least one pole piece component may be provided adjacent to the diaphragm assembly, preferably adjacent to at least one side of the diaphragm assembly. The term ‘side’ as used herein, preferably encompasses all sides of the diaphragm assembly, as defined above.

Preferably, the at least one magnet is configured such that magnetic flux aligns with vibratable layers of the diaphragm assembly. This can assist in directing the flux to the vibratable layers, and thereby enhancing the effect of the Lorentz force on the vibratable layers. The magnets are preferably configured such that the magnetic flux is perpendicular or at least substantially perpendicular to electric conductors of the vibratable layers (i.e. the direction of electric current). The magnets may also be configured such that the magnetic flux is aligned with the plane of the vibratable layers of the diaphragm assembly. This can assist in facilitating the Lorentz force acting perpendicular to layers.

In some implementations, the magnetic structure comprises at least two magnets and the magnets are arranged such that their magnetic flux constructively superimposes. The magnetic flux may constructively superimpose aligned with and/or in proximity to vibratable layers of the diaphragm assembly. This can enhance the magnetic flux, preferably the magnetic flux aligned with and/or in the vicinity of the vibratable layers.

In some implementations, the magnetic structure may comprise a plurality of magnets provided on one side of the diaphragm assembly only. This can facilitate prioritizing acoustic output on one side of the diaphragm assembly. This may be useful, for example, in loudspeakers which are configured to emit sound in one direction only. In some instances, the diaphragm assembly may be configured as a pleated structure and the plurality of magnets are provided on one side of the pleated structure only. The vibratable layers may be formed by adjacent layers of the pleated structure. As used herein, the term ‘side’ preferably connotes one side of the diaphragm assembly, preferably one side of the diaphragm assembly to which sound waves can be propagated. For example, the magnets may be provided only within pleats open to the one side (to which sound waves can be propagated). In some implementations, the magnetic structure may comprise a plurality of magnets provided between alternate pairs of adjacent vibratable layers of the diaphragm assembly. If the diaphragm assembly comprises a pleated structure, for example, this facilitates the magnets being provided on only one side of the pleated structure.

In some implementations, the magnetic structure may comprise a plurality of magnets provided on both sides of the diaphragm assembly and/or the magnets may be provided between consecutive pairs of adjacent vibratable layers of the of the diaphragm assembly. In this case, the magnets may further enhance the magnetic flux. The magnets may be provided between each pair of adjacent vibratable layers of the diaphragm assembly or only between some pairs.

According to a further aspect of the invention, there is provided an air motion transformer (AMT) electroacoustic transducer, comprising: a diaphragm assembly comprising a plurality of diaphragm layers including at least one electric conductor; and a magnetic structure; wherein the magnetic structure comprises at least one magnet positioned at least partially within the diaphragm assembly.

The magnetic structure may be the magnetic (or magnet) structure as described above.

The diaphragm assembly may preferably surround and/or encompass at least part of (for example, at least a portion of) the at least one magnet. The (geometrical) volume of the diaphragm assembly may preferably encompass at least part (for example, at least a portion of) at least one magnet. The (vibratable) layers of the diaphragm assembly may preferably surround and/or encompass at least part of (for example, at least a portion of) the at least one magnet. The (geometrical) volume formed by the (vibratable) layers of the diaphragm assembly may preferably encompass at least part (for example, at least a portion of) at least one magnet. This may encompass to the volume occupied by the (vibratable) layers and the space between the (vibratable) layers.

In some implementations, the diaphragm assembly may comprise a plurality of vibratable layers and (at least part of) the at least one magnet may be provided between adjacent vibratable layers of the diaphragm assembly. As defined above, the (at least part of) the at least one magnet may be positioned within the volume defined between adjacent vibratable layers, for example within the volume defined between the planes of two adjacent vibratable layers.

The vibratable layers of the diaphragm assembly may be vibratable via at least a portion of flexible material. The flexible material may be resilient and/or elastic. The vibratable layers of the diaphragm assembly may be vibratable via an interface (or mechanism) facilitating enhanced excursion. (Excursion referring to the extent or distance to which the vibratable layers move during vibration). The vibratable layers may be suspended via the interface (or mechanism) (for example, elastically and/or vibratably suspended). The mechanism may be any mechanism for facilitating elastic suspension.

In some implementations, the diaphragm assembly may comprise at least one vibratable layer comprising a rigid or semi-rigid portion. Such a structure may be useful for facilitating larger excursions (i.e. vibrations to a greater extent), which can be beneficial for lower frequencies. The rigid or semi-rigid portion may alternatively be referred to as stiff or having stiffness. This rigidity or stiffness can facilitate stability of a larger layer or portion, which may facilitate larger excursion. The rigid or semi-rigid portion may be suspended and vibratable via the portion of flexible material. For example, the rigid or semi-rigid portion may be connected to a structure via a flexible and/or elastic material, which may assist in facilitating vibration. In some implementations, the portion of flexible material may at least partially surround the rigid or semi-rigid portion.

In some implementations, the diaphragm assembly may comprise a first section wherein the vibratable layers have a first width and a second section wherein the vibratable layers have a second width. This can be used to configure different sections for different purposes, for example, for different frequencies.

AMT electroacoustic transducer may further comprise a frame configured to support the diaphragm assembly.

The at least one magnet may be provided on a removable magnet carrier, preferably wherein the magnet carrier is configured to reversibly retain the at least one magnet at least partially within the diaphragm assembly. In some implementations, the magnet carrier is configured to reversibly engage with a or the frame to retain the at least one magnet at least partially within the diaphragm assembly. This can facilitate changing between the magnets being provided on one or both sides of the diaphragm assembly and/or being provided in different sections of the diaphragm assembly.

The AMT electroacoustic transducer may further comprise a support provided adjacent at least one intersection of adjacent vibratable layers of the diaphragm assembly. The support may be rigid, for example a rigid polymer. This can provide support and/or structure to a flexible diaphragm. The diaphragm may be formed of a flexible thin-film or foil. The diaphragm may comprise electrically conductive tracks and/or traces for carrying electric current.

According to a further aspect of the invention, there may be provided an air motion transformer (AMT) electroacoustic transducer assembly comprising: a diaphragm assembly; a frame for supporting the diaphragm assembly; and a removable magnet carrier for carrying at least one magnet; wherein the frame is configured to reversibly engage the magnet carrier to retain the at least one magnet at least partially within the diaphragm assembly. This can facilitate reconfiguration of the magnetic structure (at least one magnet). The frame may be configured to reversibly engage the magnet carrier on both sides of the diaphragm assembly.

The AMT electroacoustic transducer assembly may comprise the magnetic structure and/or the AMT electroacoustic transducer (for example, as described above).

According to a further aspect of the invention, there is provided an air motion transformer (AMT) electroacoustic transducer, comprising: a diaphragm assembly and at least one magnet positioned at least partially within the diaphragm assembly. According to a further aspect of the invention, there is provided an air motion transformer (AMT) electroacoustic transducer, comprising: a diaphragm assembly; and a magnetic structure; wherein the magnetic structure comprises at least one magnet positioned at least partially within the diaphragm assembly. According to a further aspect of the invention, there is provided an air motion transformer (AMT) electroacoustic transducer assembly comprising: a diaphragm assembly; a frame for supporting the diaphragm assembly; and at least one magnet provided within the diaphragm assembly.

According to an aspect of the invention, there is provided a distributed magnet or magnetic structure for the air motion transformer electroacoustic transducer where at least one permanent magnet is placed within the bounds of the diaphragm stack or assembly, said magnet being positioned in between two adjacent vibratable diaphragm layers.

In some implementations, at least one additional magnet may be placed outside of the bounds of the diaphragm stack or assembly, said magnet being positioned proximate to at least one side of the diaphragm stack or assembly.

In some implementations, at least one additional pole piece element may be added to the magnet section proximate to at least one end of the diaphragm stack or assembly.

According to a further aspect of the invention, there is provided a distributed magnet or magnetic structure for the air motion transformer electroacoustic transducer where at least one permanent magnet is placed at least partially within the bounds of the diaphragm stack or assembly, said magnet being at least partially positioned in between two adjacent vibratable diaphragm layers.

In some implementations, at least one additional magnet section may be placed outside of the bounds of the diaphragm stack or assembly, said magnet being positioned proximate to at least one side of the diaphragm stack or assembly.

In some implementations, at least one additional pole piece element may be added to the magnet section proximate to at least one end of the diaphragm stack or assembly.

In some implementations, the AMT transducer may further comprise a diaphragm stack comprising a plurality of diaphragm layers such that gaps are formed between adjacent layers, where at least one magnet of the spatially distributed magnetic structure as described is wholly or partly provided in some or all of said gaps.

In some implementations, an air motion transformer (AMT) array may comprise a plurality of AMT transducers as described, provided adjacent to each other such that sound generated by the AMT transducers is emitted from each respective AMT transducer in a chosen direction relative to the device.

In some implementations, the orientation of each respective AMT transducer relative to the device may differ for some or all of the AMT transducers such that a desired sound radiation pattern can be obtained.

As used herein, a ‘diaphragm assembly’ may refer to a plurality (at least two) of diaphragm layers. As used herein, a ‘diaphragm stack’ may refer to an arrangement of a plurality (at least two) of diaphragm layers (not limited to any orientation).

The invention extends to methods and/or apparatus substantially as herein described with reference to the accompanying drawings.

Any apparatus feature as described herein may also be provided as a method feature, and vice versa.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE DRAWINGS

FIG. 1A (PRIOR ART) shows an example of the AMT operating principle, illustrating the ‘positive’ half-wave mode of operation in a cross-section view, using an example of a typical AMT transducer with a ‘classic’motor structure.

FIG. 1B (PRIOR ART) shows an example of the AMT operating principle, illustrating the ‘negative’ half-wave mode of operation in a cross-section view, using the example of a typical AMT transducer with a ‘classic’ motor structure.

FIG. 2 (PRIOR ART) shows a vertical cross-section view of one of the ‘classic’ magnetic motor structure arrangements for AMT transducers, as shown in FIG. 1A and FIG. 1B.

FIG. 3 shows an ISO view of an example of a straight-configuration AMT, the diaphragm stack having the novel distributed magnet structure in a ‘one-sided’ configuration.

FIG. 4 shows a further ISO view of the diaphragm stack of FIG. 3 with the novel distributed magnet structure in a ‘double-sided’ configuration.

FIG. 5 shows a view of a diaphragm stack in a ‘one-sided’ configuration, including a depiction of the current flow direction through the conductive traces for the ‘positive’ half-wave mode of operation.

FIG. 6 shows a view of a diaphragm stack in a ‘double-sided’ configuration, including a depiction of the current flow direction through the conductive traces for the ‘positive’ half-wave mode of operation.

FIG. 7 shows a vertical cross-section view of the magnetic structure and resulting magnetic field lines for a transducer as shown in FIG. 3 or FIG. 5.

FIG. 8 shows a vertical cross-section view of the magnetic structure and resulting magnetic field lines for the transducer shown in FIG. 4 or FIG. 6.

FIG. 9 shows an example of a wide-angle AMT configuration with a ‘meander-shaped’ or ‘pleated’ diaphragm and the novel distributed magnet structure in a ‘one-sided’ configuration, including a depiction of the current flow direction through the conductive traces for the ‘positive’ half-wave mode of operation.

FIG. 10 shows an example of a wide-angle AMT configuration with a ‘meander-shaped’ or ‘pleated’ diaphragm and the novel distributed magnet structure in a ‘double-sided’ configuration, including a depiction of the current flow direction through the conductive traces for the ‘positive’ half-wave mode of operation.

FIG. 11A shows a horizontal cross-section view of the magnetic structure and resulting magnetic field lines for the transducer as shown in FIG. 9.

FIG. 11B shows a close-up of a segment of the cross-section from FIG. 11A.

FIG. 12A shows a horizontal cross-section view of the magnetic structure and resulting magnetic field lines for the transducer as shown in FIG. 10.

FIG. 12B shows a close-up of a segment of the cross-section from FIG. 12A.

FIG. 13 shows an example of a 360-degree AMT configuration with a meander-shaped diaphragm and the novel distributed magnet structure in a ‘single-sided’ configuration showing the ‘positive’ half-wave mode of operation.

FIG. 14 shows an example of a wide-angle AMT configuration with a curved, arc-shaped diaphragm assembly and the novel distributed magnet structure using a plurality of rectangular magnets.

FIG. 15 shows an example of a wide-angle AMT configuration with a curved, arc-shaped diaphragm assembly and the novel distributed magnet structure using curved radially magnetized magnets.

### DETAILED DESCRIPTION OF THE INVENTION AND PREFERRED EMBODIMENTS

The terminology used herein is for the purpose of describing particular embodiments only and is not intended to be limiting to the invention. As used herein, the term ‘and/or’ includes any and all combinations of one or more of the associated listed items. As used herein, the singular forms ‘a’, ‘an’, and ‘the’ are intended to include the plural forms as well as the singular forms, unless the context clearly indicates otherwise. It will be further understood that the terms ‘comprises’ and/or ‘comprising’, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

This disclosure describes a novel distributed magnet or magnetic structure for use with AMT transducers developed to maximize magnetic field strength in targeted areas while minimizing the volume of magnetic material needed to construct an efficient motor. Additionally, the added benefit of using a distributed magnet array is that it provides arguably the only way of constructing an ironless motor for air motion transformer type transducers thus eliminating the need for using additional pole pieces. Finally, distributing the magnets within the diaphragm structure results in the entire transducer being contained within the footprint of the diaphragm assembly (for example, stack) itself which allows for the transducer to be sufficiently smaller compared to the prior art AMT solutions, opening up a plethora of possible real-life applications where space constraints are crucial.

Specific embodiments of the invention will now be described in detail with reference to the accompanying figures. In the following description, for purposes of explanation, numerous specific details are set forth in order to provide a thorough understanding of the present invention. It will be evident, however, to one skilled in the art that the present invention may be implemented without these specific details.

The present disclosure is to be considered as an exemplification of the invention and is not intended to limit the invention to the specific embodiments illustrated by the figures or description below.

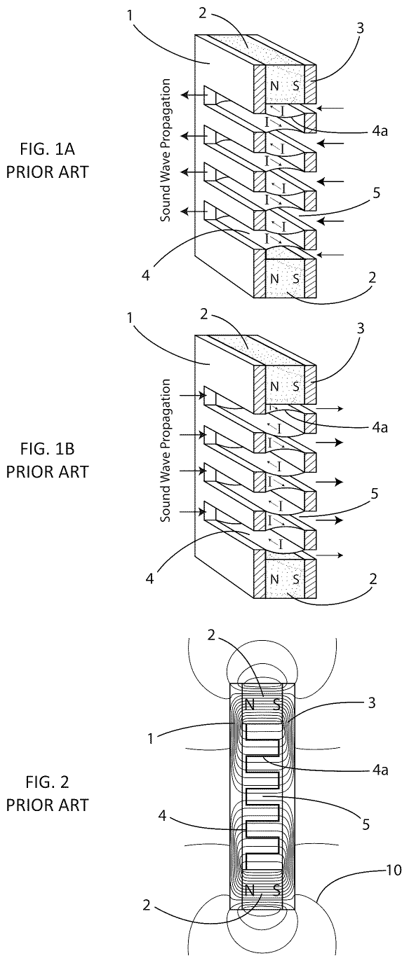

To provide a more thorough understanding of the issues resulting from a standard motor configuration, the AMT working principle known from the prior art is illustrated in FIG. 1A and FIG. 1B in a schematic fashion. The example of the AMT transducer shown comprises a ‘meander-shaped’ diaphragm 4 folded back and forth to form substantially parallel layers 4a (the diaphragm 4 typically consisting of a substrate material with electrically conductive traces or tracks on its surface), air pockets 5 that are created in between the layers 4a, magnets 2, a front pole piece 1 and a rear pole piece 3. The diaphragm 4 can therefore be described as having a ‘pleated’ structure, forming a plurality or stack of layers 4a (formed from a continuous sheet of substrate). FIG. 1A shows a ‘positive’ half-wave movement of the diaphragm layers and FIG. 1B shows a ‘negative’ half-wave movement of the diaphragm layers, and their corresponding sound wave propagation direction depending on the direction of the current I. As the current I flows along the traces in opposite directions in adjacent layers 4a of the diaphragm 4, the Lorentz force will act in opposite directions on each adjacent layer 4a (as they all sit within the same magnetic field). This creates a ‘bellows’ effect producing an acoustic output. When the current flows in a first direction, as shown in FIG. 1A, the ‘positive’ half-wave movement of the diaphragm layers 4a causes air to be expelled through the openings in the front pole piece 1 while simultaneously being sucked in through the openings in the rear pole piece 3. When the current flows in the opposite direction, as shown in FIG. 1B, the ‘negative’ half-wave movement of the diaphragm layers 4a causes air to be sucked in through the openings in the front pole piece 1 while simultaneously being expelled through the openings in the rear pole piece 3, thus creating sound pressure waves.

FIG. 2 shows a magnetic structure arrangement of a typical motor known from the prior art embodiments with magnets 2 positioned proximally to the outermost diaphragm layers 4a and the front 1 and rear 3 pole piece encasing the diaphragm structure from both sides. The picture additionally shows the magnetic field lines 10 to illustrate their distribution in the context of the entire transducer assembly. This positioning of the magnets 2 proximate to the top and bottom of the diaphragm structure with pole pieces 1 & 3 placed in front and behind the stack results in an inefficient configuration where an excessive amount of magnet volume is needed to deliver an adequate magnetic field to enable the movement of the diaphragm layers 4a. Furthermore, using pole pieces 1 & 3 introduces unwanted obstructions into the propagation path of the sound wave resulting in undesired distortion due to cavity effects causing deterioration of the sound quality.

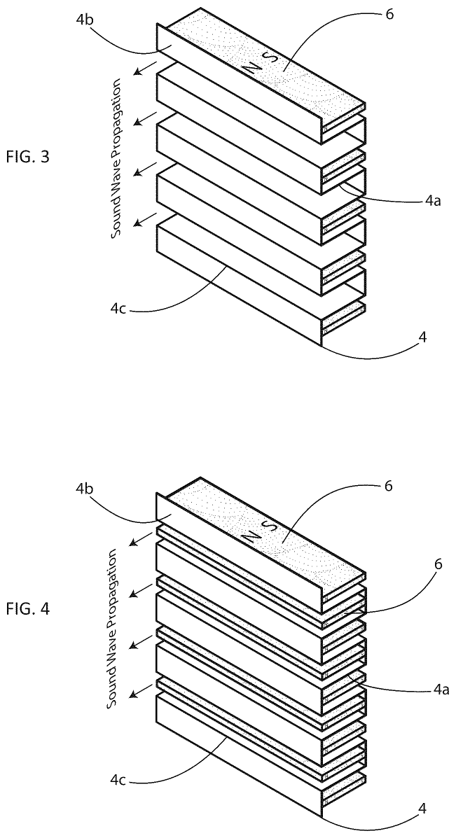

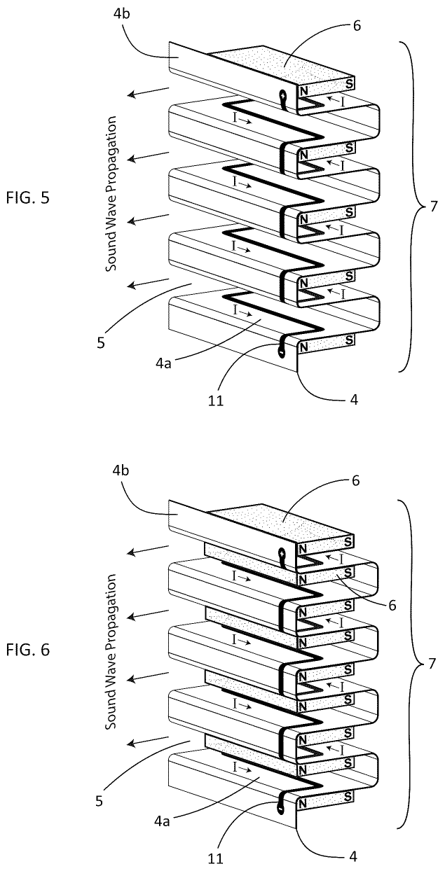

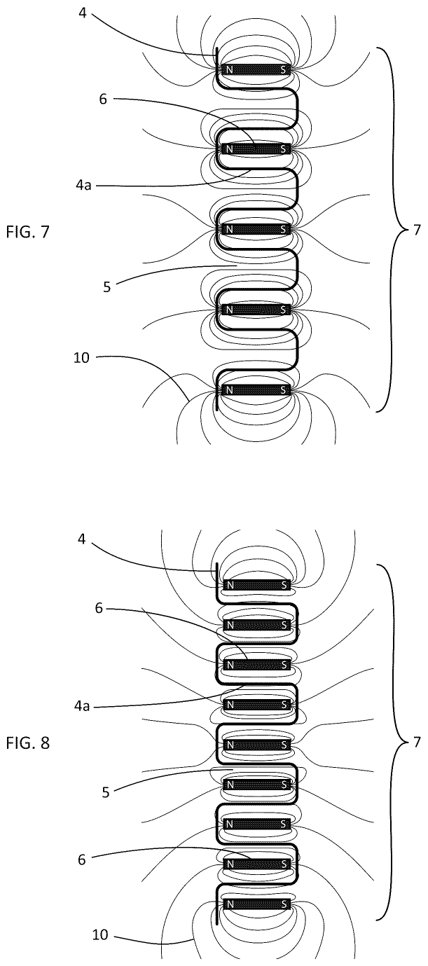

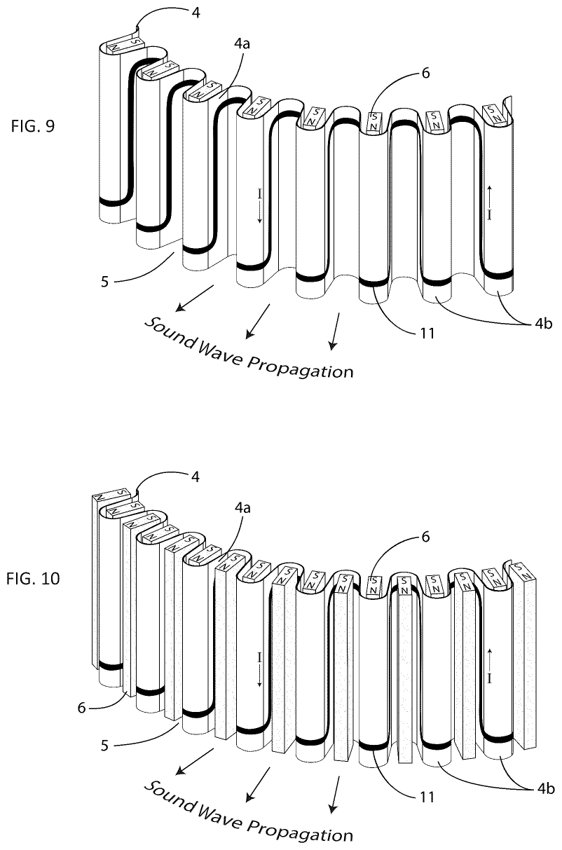

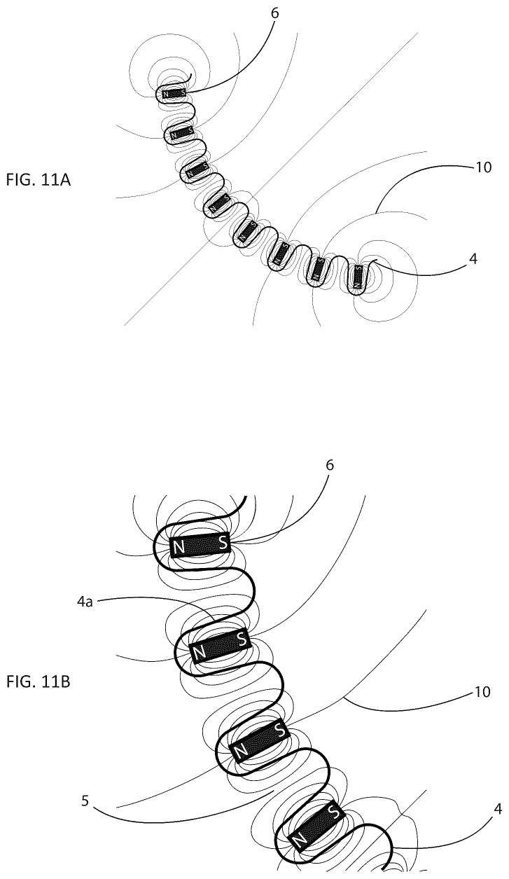

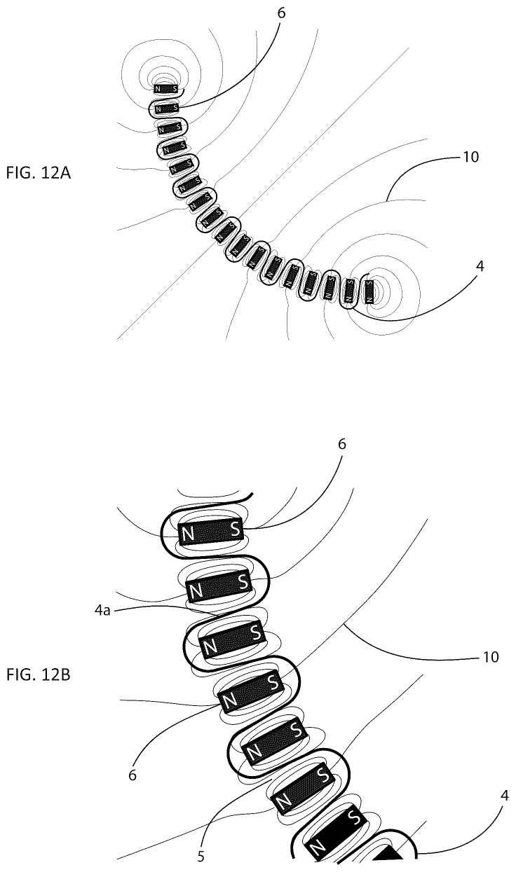

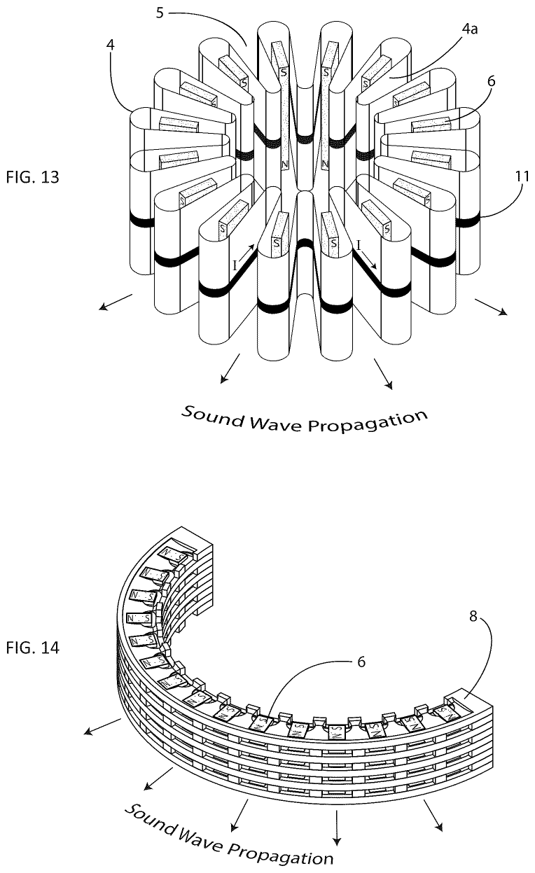

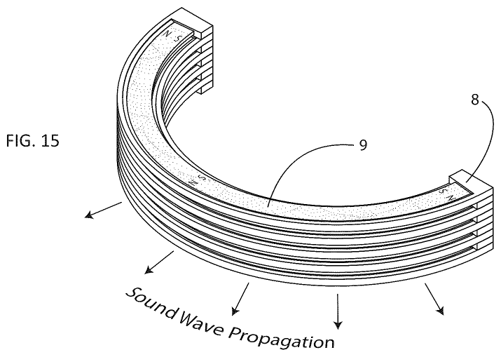

The invention prompting this disclosure describes an arrangement where one or more magnets 6 are placed directly in between the diaphragm layers 4a and positioned within the footprint of the diaphragm assembly, as illustrated in the examples in FIG. 3, FIG. 4, FIG. 5, FIG. 6, FIG. 9, FIG. 10, FIG. 13, FIG. 14, and FIG. 15. This configuration allows for using significantly smaller volumes of the permanent magnets in comparison to the prior art solutions, thus reducing the weight of the transducer and improving the efficiency of the use of raw materials. This can also reduce or eliminate the need to use pole pieces, reducing the weight further. Additionally, the delivery or provision of the magnetic flux 10 to the exact location of the diaphragm layers in close proximity to the electrically conductive traces 11 is a lot more targeted and has the added benefit of reducing stray fields, as is shown in FIG. 7, FIG. 8, FIG. 11A, FIG. 11B, FIG. 12A and FIG. 12B.

The most simple embodiment of the invention would consist of two adjacent AMT diaphragm layers 4a with a single magnet 6 or alternatively a magnet array structure consisting of multiple magnets 6 placed in the air pocket 5 between said two adjacent diaphragm layers 4a. Each diaphragm layer comprises a substrate material (a flexible foil or film) on which are provided conductive tracks or traces 11. The conductive traces 11 may be bonded on to the diaphragm 4. However, since the air motion transformer diaphragm assembly (such as a stack) 7 might consist of any number of layers 4a, the improved magnetic structure can have magnets 6 distributed in all or some of the air pockets 5 created by adjacent diaphragm layers 4a. An example of a straight-profile AMT embodiment where the magnets 6 are placed in between every diaphragm layer 4a (i.e. within every gap between layers, or between every pair of layers) of the diaphragm assembly (e.g. stack) 7 is depicted in FIG. 4 and FIG. 6 (while FIG. 3 and FIG. 5 show an embodiment in which magnets 6 are placed in between every other pair of diaphragm layers 4a).

FIGS. 3 to 6 illustrate a configuration in which the diaphragm 4 is folded back and forth to create parallel layers 4a (or at least generally parallel or near-parallel). The stack of layers 4a are joined by connecting portions 4b, on alternating sides (front, rear, front etc.) to form the ‘meander’ or ‘pleated’ shape. The layers 4a and connecting portions 4b of the illustrated embodiments are formed of a single continuous diaphragm 4 as this provides a simpler and more efficient structure (however, in some alternative embodiments this may not be the case, as it is not necessary to effect the invention). The ‘pleats’ may be formed as a square wave-type shape, as shown in FIG. 3 and FIG. 4, in which case at the intersection between layers 4a (i.e. the line along which adjacent layers 4a or layers 4a and connection portions 4b meet) there are fold lines 4c joining each of the portions of the diaphragm 4 (the layers 4a and the connecting portions 4b). In other embodiments, as illustrated in FIG. 5 and FIG. 6, the connecting portions 4b may have a more curved cross-section, the intersection between layers 4a of the diaphragm 4 assembly therefore having a curved cross-section. The connecting portions 4b of the diaphragm 4 can be pre-shaped before the assembly process and implemented into the diaphragm assembly without additional reinforcements or, alternately, the connecting portions 4b between adjacent layers 4a may take the form of the diaphragm 4 curving around a support (for example a support post).

The ‘length’ of the stack of layers 4a can be considered to be in the direction in which the layers 4a are stacked (which can also be considered to be the overall or average direction of travel of the ‘meander’ or pleated structure-and hence may be straight or curved), and the ‘height’ of the stack of layers 4a can be considered to be the dimension parallel to the intersections between layers 4a (such as fold lines 4c). The ‘width’ can be referred to as the dimension perpendicular to the length and height as defined here. Magnets 6 are oriented in such a way that the magnetic flux 10 is substantially perpendicular to the direction of the conductive traces-as required for the generation of the Lorentz force. In the configuration of FIGS. 3 to 6, and as particularly illustrated in FIG. 5 and FIG. 6, the conductive traces are arranged parallel to the intersection of the diaphragm layers 4a (for example, the fold lines 4c) and the north poles of the magnets 6 are adjacent one side of intersections (e.g. front) and the south poles are adjacent the opposite side of intersections 4c (e.g. rear); in other words, the N-S of the magnets runs from one intersection (such as a fold line 4c) to the next, and so perpendicular to the intersections (such as fold lines 4c). The N-S of the magnets can be said to run along the width of the diaphragm 4 assembly (as defined above). The conductive traces 11 can also be described as running parallel to the ‘height’ of the stack of layers 4a in this implementation. The conductive traces 11 are typically implemented as snaking or folding across the diaphragm 4 such that the current flows in opposite directions in each adjacent layer 4a, curving around to change direction (for example through 180 degrees, or at least approximately 180 degrees) as they pass into the next layer 4a. For example, the conductive traces 11 are positioned to run along the length of each layer 4a, then curve through 90°, passing through the end sections 4b and to the next layer 4a, and then back 90° again to snake back up in the opposite direction along the length of the adjacent layer 4a. Therefore, effectively, the conductive trace 11 moves through a path covering a 180° angle between adjacent layers 4a. In this way, the conductive traces 11 carry current in opposite directions on adjacent layers 4a.

Although in the examples shown in FIGS. 3 to 6 and FIGS. 9 & 10 the magnet 6 used is a single bar magnet, each layer of the magnetic structure can consist of a number of separate magnets as well. The permanent magnet used can be of any type (neodymium, ferrite, ceramic amongst others) and have any shape (bar, cube, arc, cylinder, irregular amongst others) that will be dictated by the design requirements. Similarly, FIGS. 5 & 6 and FIGS. 9 & 10 show an example implementation in which a single conductive trace runs along the diaphragm 4 assembly. However, it should be understood that the electrically conductive pathway may consist of a number of conductors (conductive traces); these typically will run parallel or near-parallel to each other.

Due to its dipole characteristic, the AMT can be used by utilizing the acoustic output from both sides of the transducer (when used for example in an ‘open’ configuration) or prioritizing only one side of the transducer in which case the acoustic output on the other side can either be absorbed or redirected-these concepts will be familiar to those skilled in the art. In either of those cases, it is possible to place magnets on both sides of the diaphragm, so in between every pair of adjacent diaphragm layers 4a (‘double-sided’ configuration) or only on one side of the diaphragm so in between every other pair (every alternate pair) of adjacent diaphragm layers 4a (‘one-sided’ configuration).

In the ‘one-sided’ arrangement, the present invention accommodates the preferable configuration where the magnets 6 can be placed in between every other pair of layers 4a allowing for the undisturbed propagation of the sound pressure waves on one side of the transducer. Examples of said configuration are illustrated in FIG. 3, FIG. 5 and FIG. 13 where the magnetic structure 6 is positioned only in the air gaps 5 open to one side (e.g. rear), while the air gaps 5 opened to the other side (e.g. front) remain unobstructed, consequently eliminating the impact of introducing unwanted acoustic cavities. By contrast, FIG. 4 and FIG. 6 show the ‘double-sided’ configuration, in which magnets 6 are placed in between every pair of layers 4a.

To show how the present invention facilitates different modes of AMT operation, such as ‘one-sided’ and ‘double-sided’ configurations, FIG. 7 and FIG. 8 show an example of the magnet distribution and the resulting spread of the magnetic field 10 for the AMT configurations shown in FIGS. 3 & 5 and FIGS. 4 & 6 respectively.

The proposed magnet placement and orientation take advantage of the symmetry of the magnetic field 10 between neighboring magnets 6 that constructively superimpose at the location of the diaphragm layers 4a introducing an added benefit of straightening the magnetic flux lines 10 at the location of the moving diaphragm layers 4a. For the “one-sided” configuration presented in FIG. 3 & FIG. 5 distributing the magnets in between every other air pocket 5 (i.e. between every other pair of layers 4a) results in a slightly weaker magnetic field 10 (as is shown in FIG. 7) than in the ‘double-sided’ configuration illustrated in FIG. 4 & FIG. 6 (the magnetic field for which is shown in FIG. 8). However it enables the elimination of all undesired objects from the acoustic path on one side of the device's output thus minimizing (or eliminating) the issues of the acoustic cavity effects. This approach can lead to further opportunities for transducer optimization, for example, by reducing the distance between certain diaphragm layers 4a to improve efficiency, while additionally reducing the overall volume of the diaphragm assembly 7 (the stack of layers 4a). However, if for the chosen application the maximum efficiency of the motor structure is to be prioritized, the ‘double-sided’ configuration can be implemented, as shown in FIG. 4 & FIG. 6 (the magnetic field for which is shown in FIG. 8), with the magnets occupying all of the air gaps 5 between the diaphragm layers 4a. Depending on the desired use case and the target specifications, the preferred motor embodiment (or a combination thereof) can be selected accordingly. Moreover, the gap between the magnets 6 and the diaphragm layers 4a can be fine-tuned to facilitate the maximum displacement of the diaphragm layers 4a while optimizing the magnetic field strength and preferably avoiding the creation of regions of high particle velocities at the duct outlets of adjacent diaphragm layers 4a.

This solution can easily be adapted to a diaphragm of any shape or curvature profile, whether round, oval or irregular amongst others, including a full 360-degree circle, a straight line profile without any curvature, as well as any chosen angle in between. Examples of such implementations with improved magnetic structure in various types of air motion transformers are presented in FIG. 3, FIG. 4, FIG. 5, FIG. 6, FIG. 9, FIG. 10, FIG. 13, FIG. 14, and FIG. 15. In particular, while FIGS. 3 to 6 show a ‘straight’ configuration, FIG. 9, FIG. 10, FIG. 14 and FIG. 15 show an arc, and FIG. 13 shows a circular configuration.

Similarly to the straight-profile example, the preferred ‘one-sided’ and the ‘double-sided’ magnet configurations are shown in FIG. 9 and FIG. 10, respectively, for a wide-angle ‘arc’ variation of the AMT. This radial AMT construction relies on the meander-shaped or pleated diaphragm 4 contained in a footprint of a full circle, a circular segment of any chosen angle or any curved path. In this implementation, each of the layers 4a may be at a slight angle to the adjacent layer 4a, so that the diaphragm 4 footprint forms an overall curve at a required angle.

The proposed magnet placement follows the same general rules as the straight-profile example where the magnetic material 6 is placed, for example, in between every pair of diaphragm layers 4a in FIG. 10 or every other pair of diaphragm layers 4a in FIG. 9. Although a single magnet is illustrated between layers 4a in FIG. 9 and FIG. 10, an array of separate magnets may alternatively be used. The distribution of the magnetic field corresponding with the FIG. 9 layout (the ‘one-sided’ configuration) is illustrated in FIG. 11A with FIG. 11B showing a close-up of a section for clarity purposes. Similarly, the distribution of the magnetic field corresponding with FIG. 10 layout (the ‘double-sided’ configuration) is illustrated in FIG. 12A with FIG. 12B showing a close-up of a section for clarity purposes.

The conductive traces 11 run up and down each layer 4a of the diaphragm such that the current flows perpendicular to the magnetic field, and in opposite directions between adjacent layers 4a. In the example illustrated in FIGS. 9 & 10, as for the example illustrated in FIGS. 3 to 6, the current flows parallel to the intersection between layers 4a. This can also be referred to as parallel to the normal of the plane containing the footprint of the ‘curve’ of the diaphragm assembly 7—or—equivalently, parallel to the axis of curvature (i.e. the axis from which the radius of curvature extends perpendicularly, or equivalently the axis of the cylinder of which the arc is part). It should be understood that although FIGS. 9 & 10 show a particular conductive trace arrangement, alternative arrangements and configurations could be used.

FIG. 13 shows an alternative implementation in which the conductors 11 follow a path substantially parallel to the top and bottom edges of the diaphragm 4 (rather than snaking back and forth in the opposite directions along the diaphragm layers 4a). In this illustrated example the diaphragm assembly 7 has a circular structure, and thus the ‘meander’ or ‘pleated’ structure forms a circular footprint. Although the example shown in FIG. 13 depicts a simplified single conductive trace 11 configuration, the electrically conductive pathway may consist of a number of conductors running parallel or near-parallel to each other.

For the arrangement shown in FIG. 13, the magnets 6 are placed such that the north pole is located at the bottom end (the base) of the diaphragm 4, and the south pole is located at the top end of the diaphragm 4 to retain the conditions necessary for the generation of the Lorentz force. The poles could of course also be reversed. In other words, the N-S poles of the magnets are aligned with the height of the diaphragm assembly 7 (wherein the height is aligned with the axis of curvature, the axis of curvature being the axis from which the radius of curvature extends perpendicularly, or, equivalently, the axis of the cylinder formed by the diaphragm assembly 7). While FIG. 13 shows is a single bar magnet placed in between every other diaphragm layer 4a in a ‘one-sided’ configuration, each section of the magnetic structure can consist of a number of separate magnets 6 and the magnetic structure 6 can be placed in between every diaphragm layer 4a for a ‘double-sided’configuration.

The arrangements may be implemented providing a frame to support the diaphragm 4 and magnets 6. This frame may comprise, by way of example, a top frame and bottom frame, which are provided at the top and bottom of the diaphragm 4, and magnets 6. Accordingly, for a curved arrangement, as illustrated in FIG. 9 and FIG. 10, the frame pieces (i.e. top and bottom frame pieces) are curved (corresponding to the overall curve of the diaphragm 4 footprint and diaphragm assembly 7 footprint). For a straight arrangement, as illustrated in FIGS. 3 to 6, the frame pieces are straight. In some instances, further supports are provided which run between the frame pieces and adjacent to each intersection between adjacent layers 4a (for example, a fold, apex or curved shape). The supports may be configured according to the arrangement of the layers 4a, and diaphragm assembly 7. The support may have a structure configured to accommodate a fold and/or curve, which may have different shapes such as a curved cross-section or angular (such as right-angled) cross-section.

In some instances, one or more magnets 6 may be provided on a substructure, such as a magnet carrier, which can slot in between the diaphragm layers 4a. These magnet carriers can be held in place by the frame, and in some instances may be reversibly insertable and removable. They can be held in place by slotting into corresponding grooves in the top and/or bottom frame pieces. The magnet carriers may be reversibly slotted into the frame to vary the number and/or position of the magnets used. For example, in this manner, the user can change from a “one-sided” configuration to a “double-sided” configuration, and vice versa. The magnet carriers are typically formed of a rigid polymer, to provide structural support without adding unnecessary weight.

Alternative arrangements of the diaphragm 4 and supports can also be used. Depending on the variation and specific construction of the AMT transducer, the diaphragm stack might include supporting elements 8 placed in between the adjacent layers to secure them in place. Examples of said AMT variation is pictured in FIG. 14 and FIG. 15, in which the diaphragm 4 is configured as arc-shaped sections containing conductive traces, each layer 4a of the diaphragm extending across the whole length of the (in this instance, curved, arc-shaped) assembly. In this case, the conductive trace runs along the (curved) length of each layer 4a, folding back over at the ends and running along the length of the adjacent layer 4a such that the current runs in opposite directions in adjacent layers 4a of the folded assembly (or stack). As such, in contrast to the embodiment described above and illustrated in FIG. 9 and FIG. 10, the direction of the current is along the arc of the curve (rather than parallel to the normal of the plane containing the curve, or, equivalently, the axis of curvature). In contrast to the embodiment described above and illustrated in FIG. 13, the diaphragm layers 4a are themselves curved and follow the footprint, rather than being provided radially. The magnets 6 are provided between the layers 4a such that the magnetic field is perpendicular to the direction of the current running through the conductive traces. In this example, the north poles are directed radially outwards in respect to the curve, and the south poles radially inwards (although they could be provided vice versa). Said support elements 8 might be designed to have a secondary purpose of fixing the proposed novel magnet structure in place. Alternatively, a dedicated fixture can be designed to fulfil the purpose of mounting the magnets in place. The support elements 8 may typically be formed of a rigid polymer, as this can provide support while keeping the weight relatively low.

In FIG. 14, a number of magnets 6 is distributed in between the curved diaphragm layers 4a. For illustration purposes, one might refer to FIG. 7 cross-section view of a diaphragm segment and translate it into the curved shape shown in FIG. 14 and FIG. 15. Similarly to previous examples, the diaphragm assembly (e.g. stack) 7 in its curved embodiment may contain the proposed magnet structure in between every diaphragm layer—the ‘double-sided’ configuration, or every other layer—the ‘one-sided’ configuration, or any combination of the two. Additionally, FIG. 14 depicts a magnet array consisting of separate, rectangular magnets oriented in a radial fashion along the curvature of the diaphragm 4 but the implementation might include a different magnet arrangement with magnets of any shape, for example, including a single curved magnet as shown in FIG. 15 or a plurality of curved magnets. Furthermore, the configurations of FIG. 13, FIG. 14 or FIG. 15 could be provided in a straight implementation.

### FURTHER EMBODIMENTS, ALTERNATIVES AND POSSIBLE IMPLEMENTATIONS

The embodiments of the presented invention can include numerous variations depending on design requirements as well as the nature of the operating environment, the desired frequency response, size of the transducer, output capability, and/or acceptable level of distortion, amongst others. The examples of the embodiments shown and described are merely a selection of preferred configurations but do not constitute an exhaustive list of all possible combinations.

The described and illustrated embodiments use (at least substantially) flat diaphragm layers but it is entirely possible to apply a corrugation to the diaphragm structure. This can be achieved by means of, for example, thermoforming, and can have beneficial effects on, for example, the mechanical break-up characteristic and can potentially extend the useable frequency range.

Similarly, while the embodiments described above have a diaphragm made of thin-film or foil, the diaphragm (or some of its parts) may alternatively be made of another type of flexible, semi-rigid or rigid substrate. A rigid or semi-rigid diaphragm can offer the advantage that the increased stiffness can maintain pistonic movement of the diaphragm over an extended frequency range.

Furthermore, there may be included a suspension in the construction of some or all of the diaphragm layers that can facilitate, for example, an extended excursion of said diaphragm layers. As used herein, the term suspension preferably connotes any means for mounting or connecting the diaphragm in such a manner that it is vibratable. Such suspension can be realized by means of, for example, thermoforming or by adding a separate flexible mounting interface made of, for example, rubber, foam-like materials or others. By way of example, a rigid or semi-rigid diaphragm portion may be surrounded (or at least partially surrounded) by a rubber connecting interface, which allows the rigid or semi-rigid diaphragm portion to vibrate.

It will be apparent to those skilled in the art that the orientation of magnet poles in the examples presented in FIG. 3, FIG. 4, FIG. 5, FIG. 6, FIG. 9, FIG. 10, FIG. 13, FIG. 14 and FIG. 15 could as well be reversed leading to an inversion of the acoustic output phase by 180□ but otherwise retaining all of the transducer's operating capabilities. Alternatively, the magnet poles could as well be rotated by 90□ or 270□ if the conductor bonded onto the diaphragm substrate material would be rearranged in a way where the direction of the current moving through the conductor would be substantially perpendicular to the magnetic field lines.

The described and illustrated curved embodiments have been arranged as a single arc. However, the invention may be implemented in a range of shapes. For example, it may be arranged as a single arc, a full 360□ circle, or an irregular shape comprising curves and/or vertices. A circular arrangement may be formed of a series of arcs (for example, four arcs each of 90□, or three arcs each of 120□) which are provided in combination to form a complete or partial circular arrangement.

The present invention can provide good directivity of sound, and so can typically be advantageously implemented in a range of scenarios. The curved implementations of the present invention may be configured to direct the sound inwardly toward the center of the effective circle formed by the speaker. This could be used, for example, for headphones. The efficient use of material offered by the present invention can offer more efficient sound reproduction at a lighter weight, improving comfort, and can allow for more creativity in the designs of such headphones. In alternative implementations, the sound may be directed outwardly from the curved speaker arrangement, for example for implementation in a standalone speaker unit. By way of example, the ‘one-sided’ configuration as described above may be implemented and arranged accordingly in order to prioritize the undisturbed sound output in a particular direction (for example, radially inwards in the case of headphones, or radially outwards in the case of a loudspeaker).

In some implementations, further magnets may be provided outside the diaphragm assembly, in addition to those provided within the diaphragm assembly. In such an implementation, the present invention can be used to augment the magnetic field provided by the ‘classic’ motor structure (with magnets provided at the proximal ends of the diaphragm assembly) by adding the novel distributed magnetic structure within the diaphragm assembly to further strengthen the magnetic field at some or all of the locations of the vibratable diaphragm.

In some implementations, the present invention can also be used in combination with the prior art solutions by utilizing both types of magnet arrangements in one transducer, for example, by applying the ‘classic’ motor structure (magnets provided outside the diaphragm assembly) to one part of the diaphragm assembly, for example, to a diaphragm section designed to reproduce high frequencies. In such a section, the diaphragm width is small, and consequently, providing an adequate magnetic field strength to facilitate the Lorentz force generation by the ‘classic’ motor structure is practical to achieve due to a small magnetic gap. In a different section of the diaphragm assembly, the novel distributed motor structure can be provided, for example, to a diaphragm section designed to reproduce low and/or midrange frequencies and in which the diaphragm width is larger. In this section configured for low and/or midrange frequencies, the magnetic gap of the ‘classic’ motor would be too large and require an undue amount of magnet volume to provide an adequate magnetic field strength to facilitate the Lorentz force generation, therefore, implementing the novel distributed magnetic structure would be preferable. Such an arrangement provides a transducer configured to yield a good output at a range of frequencies.

It should be understood that the present invention has been described above purely by way of example, and modifications of detail can be made within the scope of the invention. Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

Each feature disclosed in the description, and (where appropriate) the claims and drawings may be provided independently or in any appropriate combination.

Reference numerals appearing in the claims are by way of illustration only and shall have no limiting effect on the scope of the claims.

Further aspects of the disclosure are described in the following Clauses:
1. A distributed magnetic structure for the air motion transformer electroacoustic transducer where at least one permanent magnet is placed within the bounds of the diaphragm stack, said magnet being positioned in between two adjacent vibratable diaphragm layers.
2. A distributed magnetic structure as recited in clause 1, wherein at least one additional magnet is placed outside of the bounds of the diaphragm stack, said magnet being positioned proximate to at least one side of the diaphragm stack.
3. A distributed magnetic structure as recited in clause 2, wherein at least one additional pole piece element is added to the magnet section proximate to at least one end of the diaphragm stack.
4. A distributed magnetic structure for the air motion transformer electroacoustic transducer where at least one permanent magnet is placed at least partially within the bounds of the diaphragm stack, said magnet being at least partially positioned in between two adjacent vibratable diaphragm layers.
5. A distributed magnetic structure as recited in clause 4, wherein at least one additional magnet section is placed outside of the bounds of the diaphragm stack, said magnet being positioned proximate to at least one side of the diaphragm stack.
6. A distributed magnetic structure as recited in clause 5, wherein at least one additional pole piece element is added to the magnet section proximate to at least one end of the diaphragm stack.

1. A magnetic structure for an air motion transformer (AMT) electroacoustic transducer comprising:
a diaphragm assembly comprising a plurality of vibratable layers,
wherein the magnetic structure comprises at least one magnet positioned at least partially between two adjacent layers of the plurality of vibratable layers of the diaphragm assembly.

2. The magnetic structure of claim 1, wherein the at least one magnet is positioned at least partially within the bounds of the diaphragm assembly, preferably within the geometrical bounds of the diaphragm assembly.

3. The magnetic structure of claim 1, wherein the at least one magnet is positioned at least partially within a footprint of the diaphragm assembly.

4. (canceled)

5. The magnetic structure of claim 1, further comprising at least one further magnet outside the diaphragm assembly, preferably wherein the at least one further magnet is provided adjacent to the assembly, preferably adjacent to at least one side of the diaphragm assembly.

6. The magnetic structure of claim 1, further comprising at least one pole piece component, preferably wherein the at least one pole piece component is provided adjacent to the diaphragm assembly, preferably adjacent to at least one side of the diaphragm assembly.

7. The magnetic structure of claim 1, wherein the at least one magnet is configured such that magnetic flux aligns with the plurality of vibratable layers of the diaphragm assembly.

8. The magnetic structure of claim 1, wherein the magnetic structure comprises at least two magnets and wherein the magnets are arranged such that their magnetic flux constructively superimposes.

9. The magnetic structure of claim 8, wherein the magnetic flux constructively superimposes aligned with and/or in proximity to the plurality of vibratable layers of the diaphragm assembly.

10. The magnetic structure of claim 1, comprising a plurality of magnets provided on one side of the diaphragm assembly only, preferably wherein the diaphragm assembly is configured as a pleated structure and the plurality of magnets are provided on one side of the pleated structure only.

11. The magnetic structure of claim 1, comprising a plurality of magnets provided between alternate pairs of adjacent vibratable layers of the diaphragm assembly.

12. The magnetic structure of claim 1, comprising a plurality of magnets provided on both sides of the diaphragm assembly and/or wherein the magnets are provided between consecutive pairs of adjacent vibratable layers of the of the diaphragm assembly, preferably wherein the magnets are provided between each pair of adjacent vibratable layers of the diaphragm assembly.

13. An air motion transformer (AMT) electroacoustic transducer, comprising:
a diaphragm assembly comprising a plurality of diaphragm layers including at least one electric conductor; and
a magnetic structure;
wherein the magnetic structure comprises at least one magnet positioned at least partially within the diaphragm assembly.

14. The AMT electroacoustic transducer of claim 13, wherein the magnetic structure is the magnetic structure of claim 1.

15. The AMT electroacoustic transducer of claim 13, wherein the diaphragm assembly surrounds the at least one magnet.

16. The AMT electroacoustic transducer of claim 13, wherein the diaphragm assembly comprises a plurality of vibratable layers and the at least one magnet is provided between adjacent vibratable layers of the diaphragm assembly.

17. The AMT electroacoustic transducer of claim 13, wherein vibratable layers of the diaphragm assembly are vibratable via at least a portion of flexible material, preferably wherein vibratable layers of the diaphragm assembly are vibratable via an interface (or mechanism) facilitating enhanced excursion, more preferably wherein the vibratable layers are suspended via the interface (or mechanism).

18. The electroacoustic transducer of claim 17, wherein the diaphragm assembly comprises at least one vibratable layer comprising a rigid or semi-rigid portion, preferably wherein the rigid or semi-rigid portion is suspended and vibratable via the portion of flexible material, more preferably wherein the portion of flexible material at least partially surrounds the rigid or semi-rigid portion.

19. The AMT electroacoustic transducer claim 13, wherein the diaphragm assembly comprises a first section wherein the vibratable layers have a first width and a second section wherein the vibratable layers have a second width.

20. The AMT electroacoustic transducer of claim 13, further comprising a frame configured to support the diaphragm assembly.

21. The AMT electroacoustic transducer of claim 13, wherein at least one magnet is provided on a removable magnet carrier, preferably wherein the magnet carrier is configured to reversibly retain the at least one magnet at least partially within the diaphragm assembly, more preferably wherein the magnet carrier is configured to reversibly engage with a or the frame to retain the at least one magnet at least partially within the diaphragm assembly.

22. The AMT electroacoustic transducer of claim 13, further comprising a support provided adjacent at least one intersection of adjacent vibratable layers of the diaphragm assembly, preferably wherein the support is rigid, more preferably wherein the support is rigid polymer.

23. An air motion transformer (AMT) electroacoustic transducer assembly comprising:
a diaphragm assembly;
a frame for supporting the diaphragm assembly; and
a removable magnet carrier for carrying at least one magnet;
wherein the frame is configured to reversibly engage the magnet carrier to retain the at least one magnet at least partially within the diaphragm assembly.

24. The AMT electroacoustic transducer assembly of claim 23, wherein the frame is configured to reversibly engage the magnet carrier on both sides of the diaphragm assembly.

25. The AMT electroacoustic transducer assembly of claim 23, comprising the magnetic structure of claim 1 and/or the AMT electroacoustic transducer of claim 13.
